(19) United States
(12) Patent Application Publication
(10) Pub. No.: US 2024/0210167 A1
(43) Pub. Date: Jun. 27, 2024

(54) OPTICAL MEASUREMENT DEVICE

(71) Applicant: MITUTOYO CORPORATION, Kawasaki (JP)

(72) Inventors: Ryoichi Imaizumi, Tokyo (JP); Takumi Hayashi, Kanagawa (JP); Kohei Narumiya, Kanagawa (JP)

(21) Appl. No.: 18/539,835

(22) Filed: Dec. 14, 2023

(30) Foreign Application Priority Data
Dec. 22, 2022 (JP) 2022-205610

(51) Int. Cl. G01B 11/24

(52) U.S. Cl. CPC G01B 11/24

(57) ABSTRACT

An optical measurement device includes: a measurement region in which a measurement object is disposed; a light beam scanning unit that irradiates the measurement region with light beam and scans the light beam in a scanning direction intersecting with an irradiation direction of the light beam; a light receiving unit that receives the light beam that has passed through the measurement region and outputs a light receiving signal; a signal processing unit that outputs data indicative of a dimension in the scanning direction of the measurement object based on the light receiving signal; and an optical path cover that is configured to be removably attachable to a housing of the light beam scanning unit and covers an optical path of the light beam in a range from the housing to the measurement object.

### CROSS-REFERENCE TO RELATED APPLICATIONS

This application is based upon and claims the benefit of Japanese Patent Application No. 2022-205610, filed on Dec. 22, 2022, the entire contents of which are incorporated herein by reference.

### BACKGROUND

### Field

The present invention relates to an optical measurement device that includes a measurement region in which a measurement object is disposed, irradiates this measurement region with light beam, scans this light beam in a scanning direction, and measures a dimension and the like in this scanning direction of the measurement object.

### Description of the Related Art

There has been known an optical measurement device that includes a measurement region in which a measurement object is disposed, a light beam scanning unit that irradiates this measurement region with light beam and scans the light beam in a scanning direction intersecting with an irradiation direction of the light beam, a light receiving unit that receives the light beam that has passed through the measurement region and outputs a light receiving signal, and a signal processing unit that outputs data indicating a dimension in the scanning direction of the measurement object based on the light receiving signal.

With this configuration, due to influence of heat from a light source unit of the light beam, faint wind from a mechanism that scans the light beam, and the like, air fluctuation in an optical path of the light beam occurs at an inside of a housing of the light beam scanning unit, and this possibly results in a decrease in measurement accuracy.

Therefore, in Japanese Patent Application Publication No. 2018-179837 and Japanese Patent Application Publication No. 58-48805, an optical path cover that covers an optical path of light beam is disposed inside a housing of a light beam scanning unit. This configuration allows inhibiting air fluctuation in the optical path of the light beam at the inside of the housing of the light beam scanning unit and inhibiting the decrease in measurement accuracy.

### BRIEF DESCRIPTION OF THE DRAWINGS

FIG. 1 is a perspective view illustrating a configuration of an optical measurement device according to a first embodiment of the present invention;

FIG. 2 is a block diagram illustrating a configuration of a measurement unit 100 and a control unit 200;

FIG. 3 is a side view illustrating a configuration of the measurement unit 100 in a state of an optical path cover 130 being removed;

FIG. 4 is a side view illustrating a configuration of the measurement unit 100 in a state of the optical path cover 130 being mounted;

FIG. 5 is a perspective view illustrating the configuration of the measurement unit 100 in a state of the optical path cover 130 being removed;

FIG. 6 is a perspective view illustrating a configuration of the measurement unit 100 in a state of the optical path cover 130 being mounted;

FIG. 7 is a front view illustrating a configuration of a cover portion 131 of the optical path cover 130;

FIG. 8 is a front view illustrating a configuration of a mounting portion 132 of the optical path cover 130;

FIG. 9 is a front view illustrating a configuration of a member 140;

FIG. 10 is a top view illustrating a configuration of the measurement unit 100 in a state of the optical path cover 130 being removed;

FIG. 11 is a top view illustrating a configuration of the measurement unit 100 in a state of the optical path cover 130 being mounted;

FIG. 12 is a front view illustrating a configuration of a mounting portion 232 of an optical path cover 230 according to a second embodiment of the present invention; and

FIG. 13 is a front view illustrating a configuration of a member 240 according to the second embodiment of the present invention.

### DETAILED DESCRIPTION

An optical measurement device according to one embodiment of the present invention comprises: a measurement region in which a measurement object is disposed; a light beam scanning unit that irradiates the measurement region with light beam and scans the light beam in a scanning direction intersecting with an irradiation direction of the light beam; a light receiving unit that receives the light beam that has passed through the measurement region and outputs a light receiving signal; a signal processing unit that outputs data indicative of a dimension in the scanning direction of the measurement object based on the light receiving signal; and an optical path cover that is configured to be removably attachable to a housing of the light beam scanning unit and covers an optical path of the light beam in a range from the housing to the measurement object.

With this configuration, when the measurement object and a brace are disposed, the optical path cover can be removed from the housing of the light beam scanning unit and after the measurement object and the brace are disposed, the optical path cover can be mounted to the housing. Thus, a decrease in measurement accuracy can be inhibited without a decrease in workability.

The optical path cover may be configured to be removably attachable to the housing from an attachment/removal direction intersecting with the irradiation direction. Movement in the irradiation direction of the optical path cover relative to the housing may be restrictable when the optical path cover is attached to or removed from the housing.

With this configuration, when the optical path cover is attached to or removed from the housing, a contact of the optical path cover with the measurement object and the brace can be prevented. Therefore, the optical path cover according to the embodiment is easily mountable to the housing even after the measurement object and the brace are disposed.

The attachment/removal direction may intersect with the scanning direction. A position in the attachment/removal direction of the optical path cover to/from the housing may be adjustable. The optical path cover may be fixable to the housing in a state of the position in the attachment/removal direction being adjusted.

With this configuration, even when the position of the light beam differs from design, by adjusting the position in the attachment/removal direction of the optical path cover, the light beam can be preferably emitted to the measurement region. Therefore, the optical measurement device in which a width of the optical path cover is decreased, influence of air fluctuation is small, and environmental resistance is high can be provided.

The optical measurement device may further include: a member disposed at an emission port of the light beam of the housing; and male threads that are screwed with the member in the irradiation direction and can sandwich a part of the optical path cover with the member. The member may be slidable with the optical path cover when the optical path cover is attached or removed.

The optical path cover: may be configured to be removably attachable to the housing in an attachment/removal direction intersecting with the irradiation direction, and may include: a cover portion that covers the optical path of the light beam; and a mounting portion slidable with the member when the optical path cover is attached to or removed from the housing. The mounting portion may include groove portions disposed at positions corresponding to the male threads and extending in the attachment/removal direction.

According to the present invention, the optical measurement device in which, when the measurement object is disposed, the decrease in measurement accuracy can be inhibited without the decrease in workability can be provided.

### First Embodiment

Hereinafter, an optical measurement device according to the first embodiment of the present invention will be described with reference to the drawings.

### [Schematic Configuration]

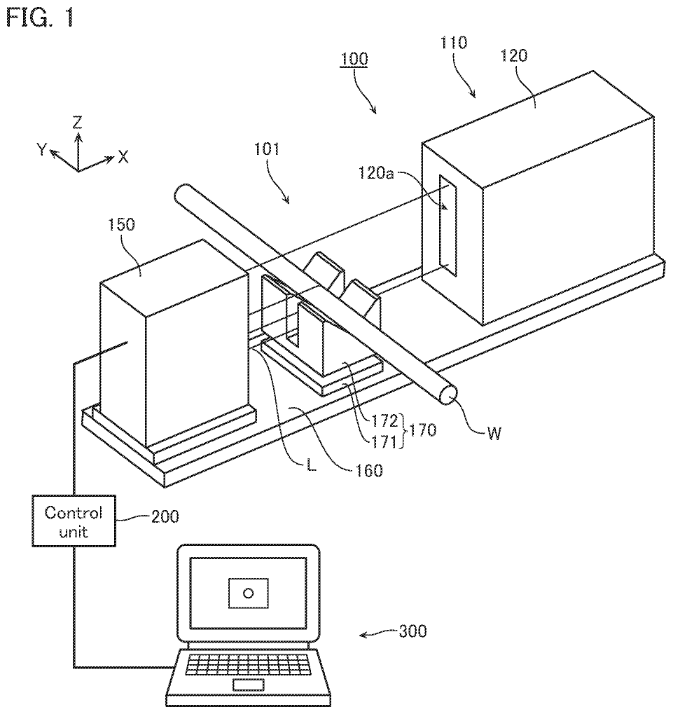

FIG. 1 is a perspective view illustrating a configuration of the optical measurement device according to the first embodiment of the present invention.

As illustrated in FIG. 1, the optical measurement device according to the embodiment includes a measurement unit 100, a control unit 200 (signal processing unit) that controls the measurement unit 100, and a PC 300 connected to the control unit 200. The measurement unit 100 includes a measurement region 101 in which a measurement object W is disposed, a light beam scanning unit 110 that irradiates the measurement region 101 with light beam (laser light L) and scans this light beam in a scanning direction (−Z-direction), a light receiving unit 150 that receives the light beam that has passed through the measurement region 101, and a connecting portion 160 that connects the light beam scanning unit 110 and the light receiving unit 150.

Note that in the example of FIG. 1, the light beam scanning unit 110 and the light receiving unit 150 are separated in an X-direction, and a space between the light beam scanning unit 110 and the light receiving unit 150 becomes the measurement region 101. Additionally, in the measurement region 101, the cylindrical measurement object W extending in a Y-direction and a brace 170 that supports this measurement object W are disposed. The brace 170 includes a pedestal portion 171 placed on an upper surface of the connecting portion 160, a supporting portion 172 that supports the measurement object W, and an adjustment mechanism (not illustrated) that can adjust a positional relation between these pedestal portion 171 and supporting portion 172 in the X-direction and the Z-direction. The light beam scanning unit 110 emits the laser light L that progresses in the −X-direction via an emission port 120a disposed in a housing 120 of the light beam scanning unit 110 and scans it in the −Z-direction.

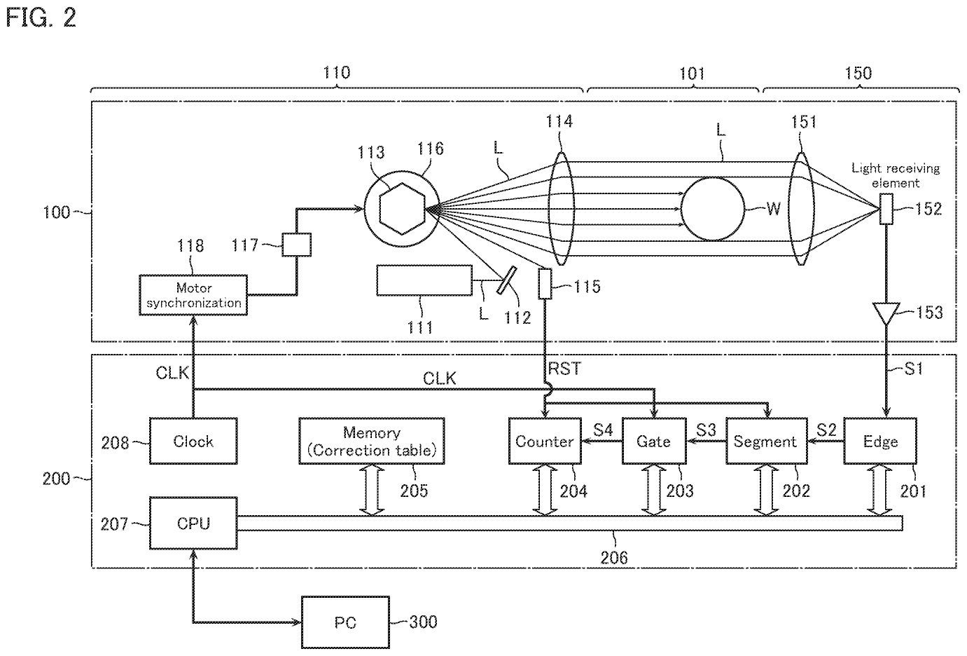

FIG. 2 is a block diagram illustrating configurations of the measurement unit 100 and the control unit 200.

The light beam scanning unit 110 includes a laser light source unit 111 that emits the laser light L, a mirror 112 by which the emitted laser light L is reflected, a polygon mirror 113 by which the laser light L reflected by the mirror 112 is further reflected, an fθ lens 114 that guides the laser light L reflected by the polygon mirror 113 to the measurement region 101, and a light receiving element 115, such as a photodiode, that outputs a reset signal RST at termination of scanning the laser light L. Additionally, the light beam scanning unit 110 includes a motor 116 that rotates the polygon mirror 113, a motor drive circuit 117 that drives the motor 116, and a motor synchronization circuit 118 that inputs a synchronous signal to the motor drive circuit 117 according to a clock signal CLK.

The light receiving unit 150 includes a condenser lens 151 that condenses the laser light L that has passed through the measurement region 101, a light receiving element 152, such as a photodiode, that receives the condensed laser light L, and an amplifier 153 that amplifies an output signal of the light receiving element 152 and outputs it as a light receiving signal S1.

The control unit 200 includes an edge detection circuit 201 that binarizes the light receiving signal S1 and outputs an edge detection signal S2, a segment selection circuit 202 that rises an edge selection signal S3 according to rising and falling of the edge detection signal S2, a gate circuit 203 that outputs an AND signal of the edge selection signal S3 and a clock signal CLK as one or a plurality of gate signals S4, a count circuit 204 that counts the number of clock pulses included in one or the plurality of gate signals S4, and a memory 205 that stores a correction table. Additionally, the control unit 200 includes a CPU 207 connected to these configurations via a bus 206 and a clock signal output circuit 208 that outputs the clock signal CLK to these configurations.

### [Operation During Dimension Measurement]

In dimension measurement, for example, the brace 170 and the measurement object W are disposed in the measurement region 101. The measurement object W is, for example, disposed at a focal point of the fθ lens 114.

Next, the laser light L is emitted from the laser light source unit 111 and rotate the polygon mirror 113. For example, when the polygon mirror 113 has a regular 16-sided prism shape and has 16 reflective surfaces, the laser light L is scanned by 16 times each time the polygon mirror 113 is rotated by one.

When the operation of the laser light L starts, the laser light L passes through the measurement region 101 and is received by the light receiving unit 150. Additionally, the light receiving signal S1 becomes a value larger than a threshold, and the edge detection signal S2 rises. Additionally, the count circuit 204 starts counting the clock pulse corresponding to an upper region of the measurement object W.

When the laser light L reaches the measurement object W, the laser light L is shielded by the measurement object W and does not pass through the measurement region 101. Additionally, the light receiving signal S1 becomes a value smaller than the threshold, and the edge detection signal S2 falls. The count circuit 204 starts counting the clock pulse corresponding to the measurement object W.

When the laser light L passes through the measurement object W, the laser light L passes through the measurement region 101 and is received by the light receiving unit 150. Additionally, the light receiving signal S1 becomes a value larger than a threshold, and the edge detection signal S2 rises. Additionally, the count circuit 204 starts counting the clock pulse corresponding to a lower region of the measurement object W.

When the laser light L is received by the light receiving element 115, the reset signal RST rises. The count circuit 204 receives the reset signal RST and outputs a counting result of the clock pulse to the CPU 207 as an edge count value. Further, the count circuit 204 resets the latched edge count value. The CPU 207, for example, refers to the correction table stored in the memory 205, corrects the edge count value, and acquires the edge count value after the correction. Afterwards, for example, among the edge count values after the correction, the edge count value corresponding to the lower region of the measurement object W is subtracted from the edge count value corresponding to the measurement object W to acquire a difference value. Moreover, this difference value is multiplied by a distance of the laser light L being scanned in the −Z-direction in one clock and outputs the result to the PC 300 as dimension data indicative of an outside diameter of the measurement object W. The PC 300 stores the output dimension data and displays the outside diameter indicated by the dimension data on a display.

### [Optical Path Cover 130]

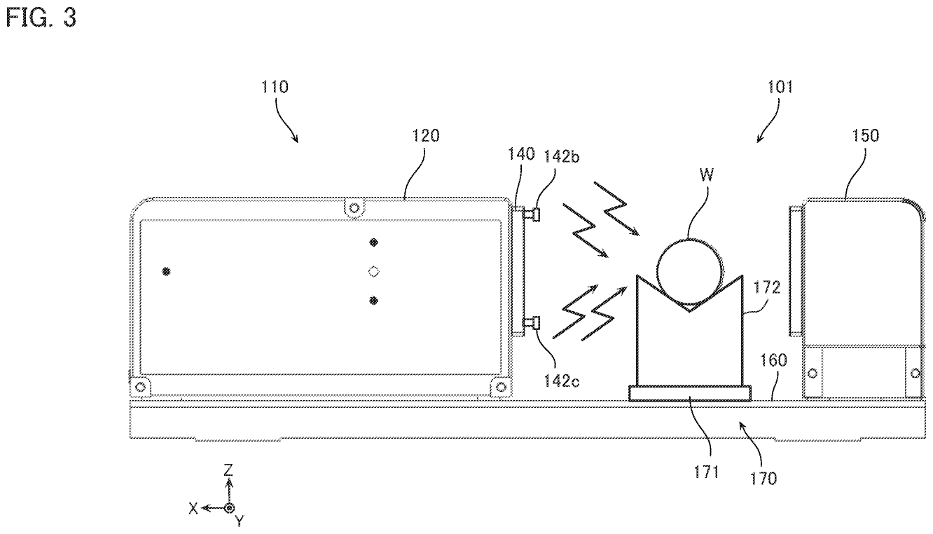

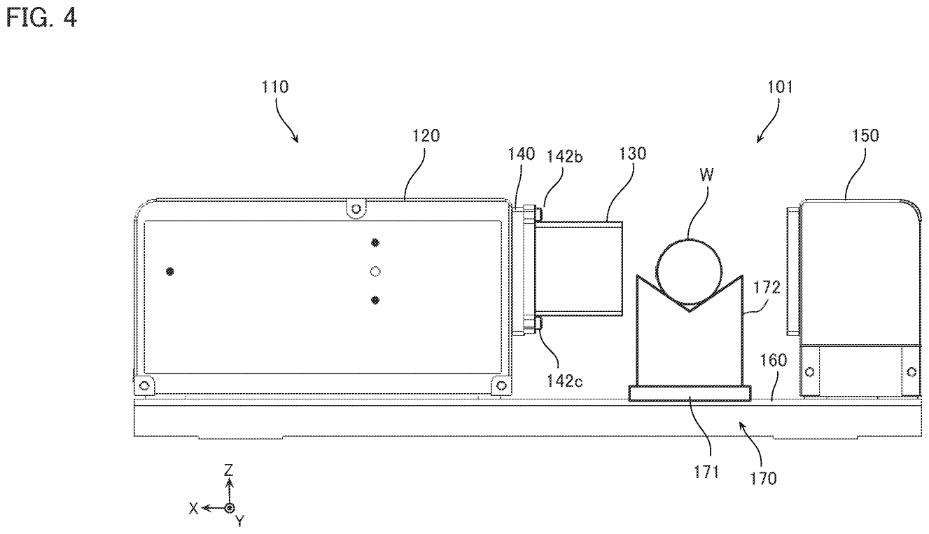

Next, with reference to FIG. 3 and FIG. 4, the optical path cover 130 will be described. FIG. 3 is a side view illustrating a configuration of the measurement unit 100 in a state of the optical path cover 130 being removed. FIG. 4 is a side view illustrating a configuration of the measurement unit 100 in a state of the optical path cover 130 being mounted.

In the optical measurement device described with reference to FIG. 1 and FIG. 2, when airflow, heat gradient, or the like is present in a range from the light beam scanning unit 110 to the measurement object W, as illustrated in FIG. 3, air fluctuation occurs in the optical path of the light beam. When air fluctuation occurs, a refractive index in the air changes according to a state of a density of the air, and a decrease in measurement accuracy possibly occurs. To inhibit this, for example, as illustrated in FIG. 4, it is considered to dispose the optical path cover 130 that covers the optical path of the laser light L in the range from the light beam scanning unit 110 to the measurement object W.

Here, to preferably inhibit air fluctuation, the optical path cover 130 preferably covers the optical path of the laser light L in the range from the light beam scanning unit 110 to the proximity of the measurement object W. However, when the optical path cover 130 approaches the measurement object W, the optical path cover 130 becomes an obstacle when the brace 170 is disposed in the measurement region 101 and the measurement object W is disposed on the brace 170, possibly causing a decrease in workability.

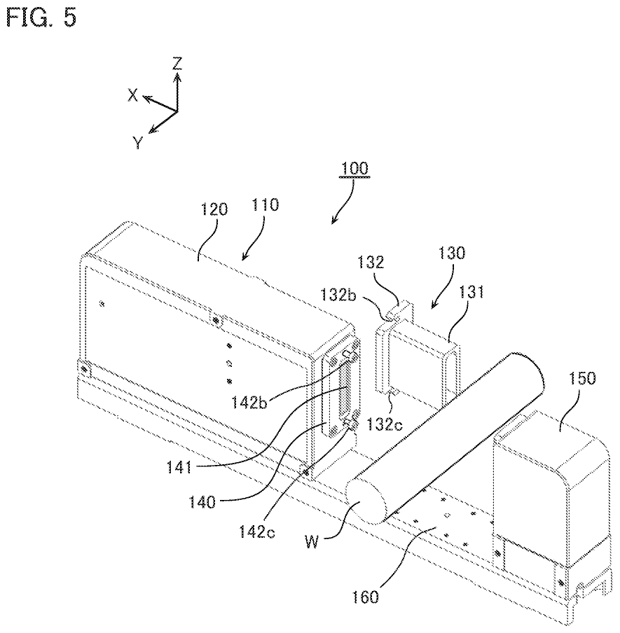

Therefore, the optical measurement device according to the embodiment includes the optical path cover 130 (FIG. 5 to FIG. 9) that is easily removably attachable to the housing 120 of the light beam scanning unit 110. With such a configuration, as illustrated in FIG. 3, the optical path cover 130 can be removed from the housing 120 when the brace 170 and the measurement object W are disposed, and as illustrated in FIG. 4, the optical path cover 130 can be mounted to the housing 120 after the brace 170 and the measurement object W are disposed. Accordingly, the decrease in measurement accuracy can be inhibited without the decrease in workability when the brace 170 and the measurement object W are disposed.

### [Configuration of Optical Path Cover 130 or the Like]

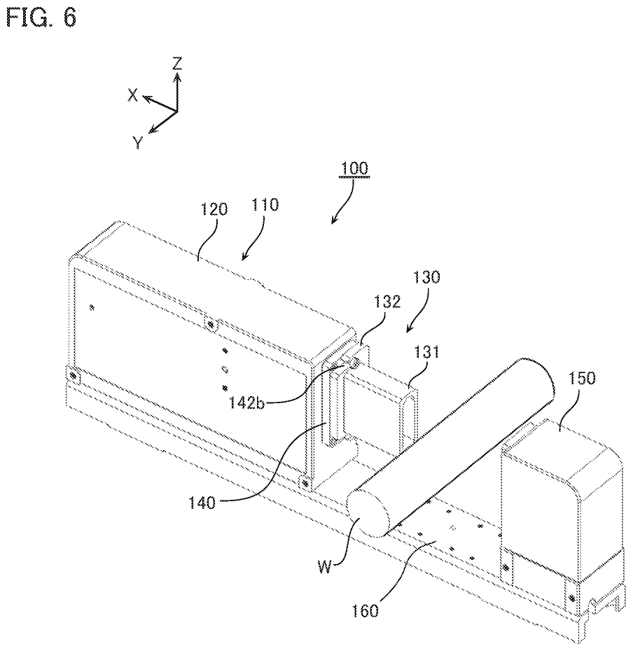

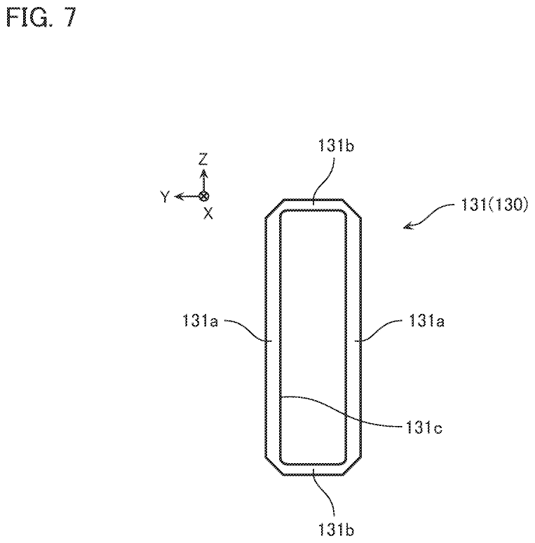

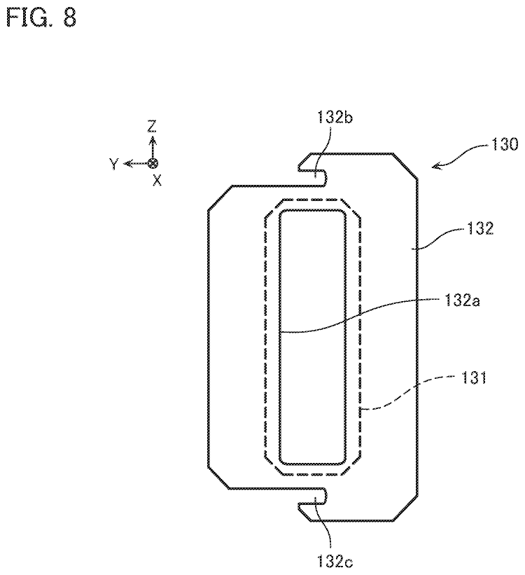

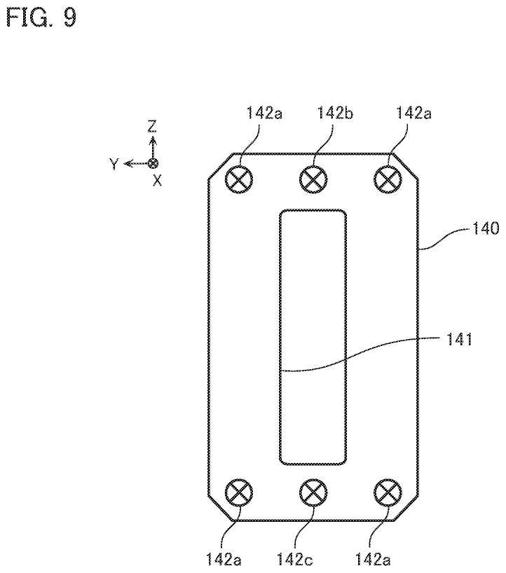

Next, with reference to FIG. 5 to FIG. 9, the configuration of the optical path cover 130 or the like will be described. FIG. 5 is a perspective view illustrating the configuration of the measurement unit 100 in a state of the optical path cover 130 being removed. FIG. 6 is a perspective view illustrating a configuration of the measurement unit 100 in a state of the optical path cover 130 being mounted. FIG. 7 is a front view illustrating a configuration of a cover portion 131 of the optical path cover 130. FIG. 8 is a front view illustrating a configuration of a mounting portion 132 of the optical path cover 130. FIG. 9 is a front view illustrating a configuration of a member 140.

As illustrated in FIG. 5, the optical measurement device according to the embodiment includes the optical path cover 130 and the member 140 configured to allow the optical path cover 130 to be removably attachable to the housing 120.

The optical path cover 130 includes the cover portion 131 that covers the optical path of the laser light L in the range from the light beam scanning unit 110 to the measurement object W and the mounting portion 132 configured to be removably attachable to the member 140.

The cover portion 131 includes an approximately square tube shape extending in an irradiation direction (−X-direction) and the scanning direction (−Z-direction) of the laser light L. As illustrated in FIG. 7, the cover portion 131 includes a pair of wall portions 131a that separate in the Y-direction and a pair of wall portions 131b that separate in the Z-direction. The pair of wall portions 131a each extend in the X-direction and the Z-direction. The pair of wall portions 131b each extend in the X-direction and the Y-direction. A region 131c surrounded by these pair of wall portions 131a and pair of wall portions 131b is a region through which the laser light L passes.

The mounting portion 132 has an approximately rectangular shape extending in the Y-direction and the Z-direction. As illustrated in FIG. 8, at a center of the mounting portion 132, a through-hole 132a extending in the Z-direction is provided. The through-hole 132a is a region through which the laser light L passes. Groove portions 132b, 132c are disposed at respective upper end and lower end of the mounting portion 132. The groove portions 132b, 132c extend in the Y-direction from positions corresponding to male threads 142b, 142c (FIG. 9) described later, respectively, to end portions (end portions at a positive side in the Y-direction in the illustrated example) at one side in the Y-direction of the mounting portion 132, and end portions of the groove portions 132b, 132c at one side are open.

As illustrated in FIG. 9, the member 140 has an approximately rectangular shape extending in the Y-direction and the Z-direction. At a center of the member 140, a through-hole 141 extending in the Z-direction is provided. The through-hole 141 is a region through which the laser light L passes. A width in the X-direction of the through-hole 141 may be equal to a width in the X-direction of the region 131c (FIG. 7) and a width in the X-direction of the through-hole 132a (FIG. 8) or may be larger than these widths. At four corners of the member 140, respective male threads 142a that fix the member 140 to the housing 120 are disposed. Additionally, in respective upper and lower regions of the through-hole 141, the male threads 142b, 142c screwed with the member 140 from a negative side in the X-direction are disposed.

### [Attachment and Removal of Optical Path Cover 130]

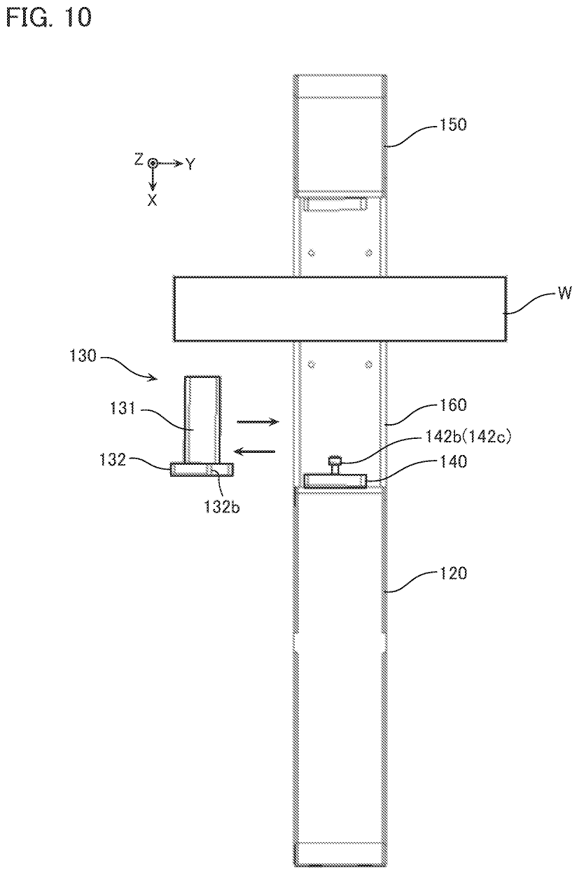

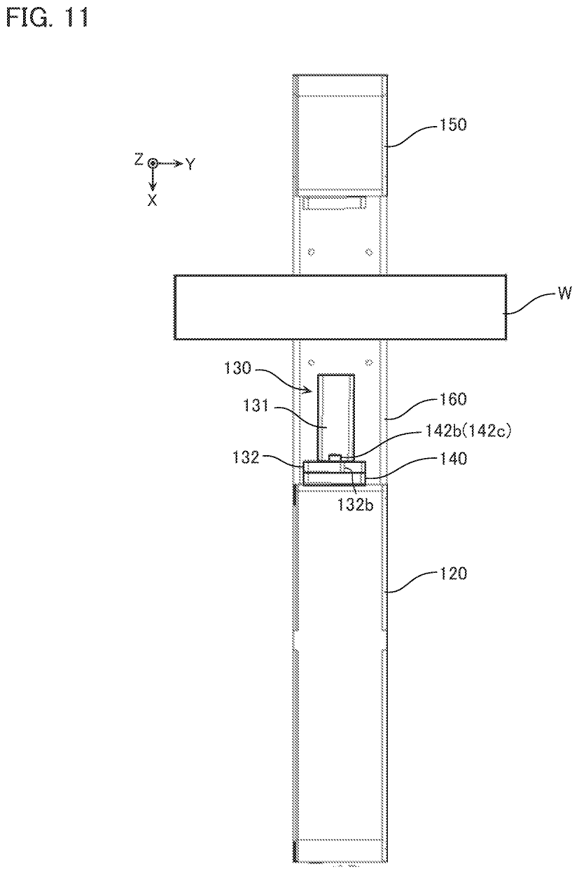

Next, with reference to FIG. 10 and FIG. 11, the attachment and removal of the optical path cover 130 will be described. FIG. 10 is a top view illustrating a configuration of the measurement unit 100 in a state of the optical path cover 130 being removed. FIG. 11 is a top view illustrating a configuration of the measurement unit 100 in a state of the optical path cover 130 being mounted.

When the optical path cover 130 is mounted, as illustrated in FIG. 10, the male threads 142b, 142c are set to be in a state of projecting to the negative side in the X-direction. Next, the mounting portion 132 of the optical path cover 130 is inserted into a region between the member 140 and heads of the male threads 142b, 142c in the positive side in the Y-direction. In this respect, the mounting portion 132 slides to the member 140.

Additionally, screw portions of the male threads 142b, 142c are inserted into the groove portions 132b, 132c. Next, as illustrated in FIG. 11, a position in the Y-direction of the optical path cover 130 relative to the housing 120 is adjusted. Next, the male threads 142b, 142c are fastened and the mounting portion 132 is sandwiched by the member 140 and the heads of the male threads 142b, 142c to fix the optical path cover 130 to the housing 120.

When the optical path cover 130 is removed, the male threads 142b, 142c are loosened. Next, as illustrated in FIG. 10, the mounting portion 132 of the optical path cover 130 is pulled out to a negative side in the Y-direction from the region between the member 140 and the heads of the male threads 142b, 142c.

That is, in the embodiment, the optical path cover 130 is configured to be removably attachable to the housing 120 in an attachment/removal direction (the Y-direction in the embodiment) intersecting with the irradiation direction of the laser light L (−X-direction). Additionally, when the optical path cover 130 is attached to or removed from the housing 120, movement in the irradiation direction (−X-direction) of the optical path cover 130 relative to the housing 120 can be restricted.

With this configuration, when the optical path cover 130 is attached to or removed from the housing 120, a contact of the optical path cover 130 with the brace 170 (FIG. 1) and the measurement object W can be prevented. Therefore, the optical path cover 130 according to the embodiment is easily mountable to the housing 120 even after the brace 170 (FIG. 1) and the measurement object W are disposed.

With this configuration, for example, in a case where measurement is performed while the optical path cover 130 is removed and a variation in the measurement result is large, the optical path cover 130 can be mounted for high accuracy. In this case, since the optical path cover 130 does not contact the brace 170 (FIG. 1) or the measurement object W, measurement can be performed with the same conditions.

Additionally, in the embodiment, the position in the Y-direction of the optical path cover 130 relative to the housing 120 is adjustable, and the optical path cover 130 can be fixed to the housing 120 with the position in the attachment/removal direction adjusted.

Here, the optical measurement device as described above allows reducing influence of air fluctuation as the widths in the X-direction of the region 131c (FIG. 7) and the through-hole 132a (FIG. 8) become small. Additionally, an invasion of a foreign matter or the like from the outside can be inhibited.

On the other hand, in the optical measurement device as described above, there may be a case where the position in the Y-direction of the laser light L differs from design due to a manufacturing error of the polygon mirror 113 (FIG. 2), an assembly error of each of the configurations, and the like. Therefore, unless the widths in the X-direction of the region 131c (FIG. 7) and the through-hole 132a (FIG. 8) are increased to some extent, the optical path cover 130 obstructs the laser light L and preferred measurement possibly cannot be performed.

However, in the embodiment, even when the position in the Y-direction of the laser light L differs from the design, by adjusting the position of the optical path cover 130 in the Y-direction, the laser light L can be preferably emitted to the measurement region 101. Therefore, the optical measurement device in which the width of the region 131c (FIG. 7) in the X-direction and the width of the through-hole 132a (FIG. 8) in the X-direction are decreased, the influence of air fluctuation is small, and environment resistance is high can be provided.

### Second Embodiment

Next, an optical measurement device according to the second embodiment of the present invention will be described. In the following description, same reference numerals are given to parts similar to those of the first embodiment to omit the description.

The optical measurement device according to the second embodiment is basically configured similarly to the optical measurement device according to the first embodiment. However, the optical measurement device according to the second embodiment includes an optical path cover 230 and a member 240 instead of the optical path cover 130 and the member 140.

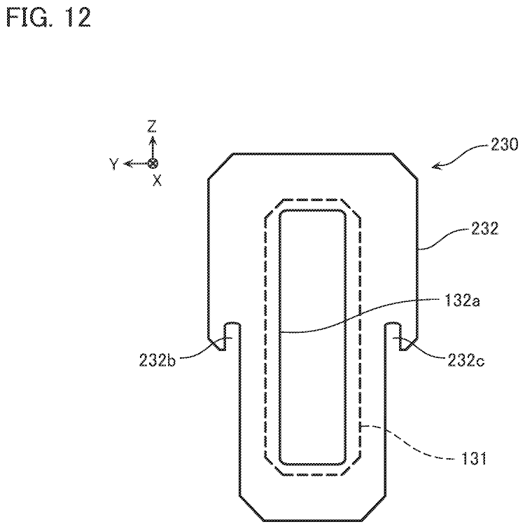

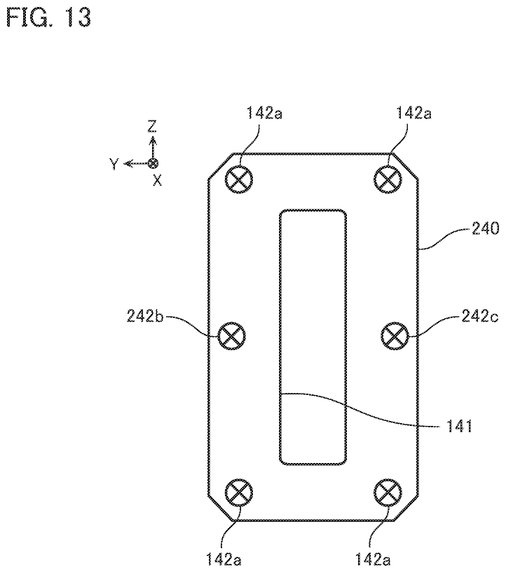

FIG. 12 is a front view illustrating a configuration of a mounting portion 232 of the optical path cover 230. The optical path cover 230 is basically configured similarly to the optical path cover 130. However, the optical path cover 230 includes the mounting portion 232 instead of the mounting portion 132. The mounting portion 232 is basically configured similarly to the mounting portion 132. However, the mounting portion 232 does not include the groove portion 132b, 132c. Additionally, at respective one end and the other end in the Y-direction of the mounting portion 232, groove portions 232b, 232c are disposed. The groove portions 232b, 232c extend in the Z-direction from positions corresponding to male threads 242b, 242c (FIG. 13) described later, respectively, to end portions (end portions at a negative side in the Z-direction in the illustrated example) at one side in the Z-direction of the mounting portion 232, and end portions at one side are open.

FIG. 13 is a front view illustrating a configuration of the member 240. The member 240 is basically configured similarly to the member 140. However, the member 240 does not include the male thread 142b, 142c. Additionally, in regions at the positive side in the Y-direction and the negative side in the Y-direction with respect to the through-hole 141, the male threads 242b, 242c screwed with the member 240 from the negative side in the X-direction are disposed, respectively.

The optical path cover 230 according to the second embodiment is basically removably attachable to the housing 120 by the method similar to that of the optical path cover 130 according to the first embodiment. However, in the first embodiment, the attachment/removal direction of attaching or removing the optical path cover 130 to/from the housing 120 is the Y-direction. On the other hand, in the second embodiment, the attachment/removal direction of attaching or removing the optical path cover 230 to/from the housing 120 is the Z-direction.

### OTHER EMBODIMENTS

In the first embodiment, the example in which the optical path cover 130 is attached to or removed from the housing 120 via the member 140 has been described. However, the optical path cover 130 may be directly removably attachable to the housing 120. In such a case, the housing 120 may have a surface slidable with the mounting portion 132 when the optical path cover 130 is attached or removed. Additionally, the male threads 142b, 142c may be screwed with the housing 120.

What is claimed is:

1. An optical measurement device comprising:
a measurement region in which a measurement object is disposed;
a light beam scanning unit that irradiates the measurement region with light beam and scans the light beam in a scanning direction intersecting with an irradiation direction of the light beam;
a light receiving unit that receives the light beam that has passed through the measurement region and outputs a light receiving signal;
a signal processing unit that outputs data indicative of a dimension in the scanning direction of the measurement object based on the light receiving signal; and
an optical path cover that is configured to be removably attachable to a housing of the light beam scanning unit and covers an optical path of the light beam in a range from the housing to the measurement object.

2. The optical measurement device according to claim 1, wherein
the optical path cover is configured to be removably attachable to the housing from an attachment/removal direction intersecting with the irradiation direction.

3. The optical measurement device according to claim 2, wherein
movement in the irradiation direction of the optical path cover relative to the housing is restrictable when the optical path cover is attached to or removed from the housing.

4. The optical measurement device according to claim 3, wherein
the attachment/removal direction intersects with the scanning direction,
a position in the attachment/removal direction of the optical path cover to/from the housing is adjustable, and
the optical path cover is fixable to the housing in a state of the position in the attachment/removal direction being adjusted.

5. The optical measurement device according to claim 1, further comprising:
a member disposed at an emission port of the light beam of the housing; and
male threads that are screwed with the member in the irradiation direction and are able to sandwich a part of the optical path cover with the member, wherein
the member is slidable with the optical path cover when the optical path cover is attached or removed.

6. The optical measurement device according to claim 5, wherein
the optical path cover:
is configured to be removably attachable to the housing in an attachment/removal direction intersecting with the irradiation direction; and
includes:
a cover portion that covers the optical path of the light beam; and
a mounting portion slidable with the member when the optical path cover is attached to or removed from the housing, and
the mounting portion includes groove portions disposed at positions corresponding to the male threads and extending in the attachment/removal direction.
